(19) United States
(12) Patent Application Publication
(10) Pub. No.: US 2022/0335287 A1
(43) Pub. Date: Oct. 20, 2022

(54) SYSTEMS AND METHODS FOR DYNAMICALLY UPDATING A NEURAL NETWORK HAVING A PLURALITY OF KERNELS

(71) Applicant: NVIDIA Corporation, Santa Clara, CA (US)

(72) Inventors: Donald Lee Brittain, Pasadena, CA (US); Maxim Leonidovich Grishin, Tula (RU); Christopher Michael VanderKnyff, Raleigh, NC (US); Gaoyan Xie, Amherst, MA (US)

(21) Appl. No.: 17/234,477

(22) Filed: Apr. 19, 2021

(51) Int. Cl. G06N 3/08; G06K 9/62

(52) U.S. Cl. CPC G06N 3/08; G06K 9/6202; G06K 9/6215; G06K 9/6228; G06K 9/6288

(57) ABSTRACT

In various examples, systems and methods are disclosed herein for dynamically updating a neural network having a plurality of kernels. The system may identify a first subset of kernels from the plurality of kernels in the neural network. The system may then determine the characteristics of each respective kernel in the first subset. The system may then compare the characteristics of the respective kernels in the first subject to a dynamic rule set. In response to the system comparing the characteristics of the respective kernels in the first subset to the dynamic rule set, the system identifies a second subset of the first subset based on the comparing, automatically generates instructions to combine the second subset of kernels, and updates the neural network based on the one or more instructions. The neural network may have a simplified compute graph based on the above dynamic updating systems and methods.

### BACKGROUND

The present disclosure is directed to techniques for machine learning, specifically techniques for designing and updating neural networks.

### SUMMARY

Deep learning models typically include a series of computation steps (commonly called “layers”) that process big blocks of data in a (mostly) sequential fashion. More generally, the processing takes place with data flowing through a graph structure, where nodes on the graph represent the layer processing steps. In general, layers can take inputs from one or more earlier nodes, and layer output can feed one or subsequent nodes.

The processing that takes place in each node is often characterized by being either “compute bound” or “memory bound”. If a node is compute bound, it means that processing is limited by how fast the underlying hardware (typically, a GPU) can perform the specified computation, whereas if a node is memory bound, its processing is limited by how fast it can fetch its input and/or store its output.

A key step used to optimize inference execution is to combine groups of processing steps together (wherever possible) so that data “flows” through the computation graph with as few memory fetches and stores as possible. This is typically done by combining a compute-bound step with one or more adjacent memory bound operations. In the optimal situation, this has the positive effect of eliminating many memory access bottlenecks, thereby making the overall execution time faster while also appreciably reducing power consumption (since, in general, it takes more power to fetch and/or store data in main memory than to “compute with” that data).

Improvements also come when multiple memory bound layers are combined into a single processing step, or when processing is simplified to tightly match specific model or problem constraints (e.g. by taking advantage of problem-specific knowledge such as the spatial or temporal resolutions of expected inputs or by knowing the exact number of inputs the model uses at layers that can, in general, process a broad or variable range of input values).

In the context of a GPU, since the processing step for each node involves launching one or more “kernels” (i.e., well-defined execution units, typically run in a parallel fashion on a GPU), the process of combining multiple layers of processing into a single step is referred to as “kernel fusing”.

One approach for kernel fusing includes offering a set of “pre-fused” functions in a library, then adding a step to the automation logic that builds code for deployment so that it searches for pre-fused options before otherwise settling for stringing together unfused kernels (when no pre-fused options are available). However, it is impractical to provide a full library of fused kernels representing even the most common layer patterns that appear in most deep learning models.

Another approach includes manually fusing kernels that are specific to a given model. For critical networks, manual fusing can achieve good performance. But the costs (in both time to ship and the need to allocate critical programming resources) can make this an impractical choice for all but the most important projects. In some embodiments, another implementation may include implantation of a tensor compiler that offers limited flexibility and good performance over a broad range of computation scenarios rather than great performance over a more limited set of fusable building block operations.

Accordingly, to overcome the limitations of current approaches for kernel fusing, systems and methods are described herein for dynamically updating a neural network having a plurality of kernels. The system may identify a first subset of kernels from the plurality of kernels in the neural network (e.g., identification may be accomplished by using preprocessing fusing of layers using UpscaleConcat). The system may then determine the characteristics of each respective kernel in the first subset. For example, the system may determine the specific types of operations to be performed by each of the kernels and which kernels are used for inputs for other kernels. The system may then compare the characteristics of the respective kernels in the first subset to a dynamic rule set. The dynamic rule set may be generated by a processing circuitry based on a multiple of factors including pre-populated rules and dynamically generated rules based on the determined characteristics of the kernels (e.g., processing circuitry may remove Batch Norm from a Convolution-BatchNorm sequence). In response to the system comparing the characteristics of the respective kernels in the first subset to the dynamic rule set, the system identifies a second subset of the first subset based on the comparing, automatically generates instructions to combine the second subset of kernels, and updates the neural network based on the one or more instructions. For example, the system may determine that all the kernels in the second subset are similar and maybe represented as a summation programming function, and thus the system creates a function based on summation programming and updates the neural network by executing the summation programming function on the kernels in the second subset. The neural network may have a simplified compute graph based on the above dynamic updating systems and methods.

In some embodiments, the system may identify a first subset of kernels from the plurality of kernels in the neural network for a hardware resource (e.g., an amount of memory required for operations for a set of kernels of a compute graph in a neural network). The system may then determine characteristics of each respective kernel in the first subset. The system may then determine a hardware resource level of the hardware resource based on the identified first subset of kernels. For example, the system may determine that it requires 400 kilobytes of memory of cache to perform the operations in the first subset of kernels. In this scenario, the hardware may allocate this amount of memory for the operations. The system may then compare the characteristics of the respective kernels in the first subject to a dynamic rule set. In response to the system comparing the characteristics of the respective kernels in the first subset to the dynamic rule set, the system identifies a second subset of the first subset based on the comparing, automatically generates instructions to combine the second subset of kernels, and updates the neural network based on the one or more instructions. The system may then adjust the hardware resource level based on the updated neural network. For example, if the compute graph of the neural network is simplified, then memory allocation may be less (e.g., the system may only need 300 kilobytes of cache). In this scenario, the system may reduce the cache from 400 to 300 based on the adjusted compute graph of the neural network.

In some embodiments, the system may inspect a dynamically updated neural network comprising a plurality of kernels. The system may identify a first subset of kernels from the plurality of kernels. The system may then determine the characteristics of each respective kernel in the first subset. The system may then compare the characteristics of the respective kernels in the first subject to a dynamic rule set. In response to the system comparing the characteristics of the respective kernels in the first subset to the dynamic rule set, the system identifies a second subset of the first subset based on the comparing, automatically generates instructions to combine the second subset of kernels, and updates the neural network based on the one or more instructions. The system may then, in response to updating the neural network, inspect a specific network location. The specific network location may be located away from a network location of the second subset. For example, an analytics probe may be implemented via control circuitry to monitor computing operations at a specific location in the neural network which is not at the location of the compute graph proximate to the second subset. In this way, the system may analyze results before and after instructions have been sent to dynamically update the neural network.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1A is an illustration of an example of a neural network including a plurality of kernels, in accordance with some embodiments of the present disclosure;

FIG. 1B is an illustration of an example of a neural network including a first subset of a plurality of kernels, in accordance with some embodiments of the present disclosure;

FIG. 1C is an illustration of an example of a neural network including a fused kernel, in accordance with some embodiments of the present disclosure;

FIG. 2A is an illustration of an example of a neural network including a plurality of kernels and corresponding hardware resource value, in accordance with some embodiments of the present disclosure;

FIG. 2B is an illustration of an example of a neural network including a first subset of a plurality of kernels and corresponding hardware resource value, in accordance with some embodiments of the present disclosure;

FIG. 2C is an illustration of an example of a neural network including a fused kernel and corresponding hardware resource value, in accordance with some embodiments of the present disclosure;

FIG. 2D is an illustration of an example of a neural network including a plurality of kernels, in accordance with some embodiments of the present disclosure;

FIG. 2E is an illustration of an example of a neural network including a fused kernel, in accordance with some embodiments of the present disclosure;

FIG. 3A is an illustration of an example of a generated neural network flow diagram for detecting aliasing in a graphical output, in accordance with some embodiments of the present disclosure;

FIG. 3B is an illustration of an example of a generated heatmap based on an input image to a neural network, in accordance with some embodiments of the present disclosure;

FIG. 3C is an illustration of an example of adding an analysis layer to the neural network, in accordance with some embodiments of the present disclosure;

FIG. 3D is an illustration of an example of mixing the input and output kernels in the neural network, in accordance with some embodiments of the present disclosure;

FIG. 3E is an illustration of an example of alteration of the graphical user interface based on the neural network, in accordance with some embodiments of the present disclosure;

FIG. 3F is an illustration of an example of quantizing the output of the kernels of the neural network to a lower-precision numerical format, in accordance with some embodiments of the present disclosure;

FIG. 3G is an illustration of an example of a modified graphical user interface based on quantizing the output of the kernels of the neural network to a lower-precision numerical format, in accordance with some embodiments of the present disclosure;

FIG. 3H is an illustration of an example of a modified neural network based on a reduced size input kernel, in accordance with some embodiments of the present disclosure;

FIG. 4 is a block diagram of an example computing devices suitable for use in implementing some embodiments of the present disclosure;

FIG. 5A illustrates an exemplary inference and/or training logic used to perform inferencing and/or training operations suitable for use in implementing some embodiments of the present disclosure;

FIG. 5B illustrates an exemplary inference and/or training logic suitable for use in implementing some embodiments of the present disclosure;

FIG. 6 illustrates an exemplary training and deployment of a deep neural network suitable for use in implementing some embodiments of the present disclosure;

FIG. 7 is an example of an illustrative flowchart of dynamically updating a neural network comprising a plurality of kernels, in accordance with some embodiments of the present disclosure;

FIG. 8 is an example of an illustrative flowchart of dynamically updating a neural network comprising a plurality of kernels for a hardware resource, in accordance with some embodiments of the present disclosure; and

FIG. 9 is an example of an illustrative flowchart of inspecting a dynamically updated neural network comprising a plurality of kernels, in accordance with some embodiments of the present disclosure.

### DETAILED DESCRIPTION

In some embodiments, processing circuitry may initiate and/or execute operations to perform systems and methods for dynamically updating a neural network having a plurality of kernels disclosed herein. The processing circuitry may identify a first subset of kernels from the plurality of kernels in the neural network. The processing circuitry may then determine the characteristics of each respective kernel in the first subset. For example, the system may determine the specific types of operations to be performed by each of the kernels and which kernels are used for inputs for other kernels. The processing circuitry may then compare the characteristics of the respective kernels in the first subject to a dynamic rule set. The dynamic rule set may be generated by processing circuitry based on a multiple of factors including pre-populated rules and dynamically generated rules based on the determined characteristics of the kernels and/or how well these rules run on particular hardware. In response to the processing circuitry comparing the characteristics of the respective kernels in the first subset to the dynamic rule set, the processing circuitry identifies a second subset of the first subset based on the comparing, automatically generates instructions to combine the second subset of kernels, and updates the neural network based on the one or more instructions. For example, the processing circuitry may determine that all the kernels in the second subset are similar and maybe represented as a summation programming function, and thus the processing circuitry creates a function based on summation programming and updates the neural network by executing the summation programming function on the kernels in the second subset. The neural network may have a simplified compute graph based on the above dynamic updating systems and methods. The above technique coupled with run time compilation of the (quickly) generated fused kernel source code provides for retrieval of code that runs very close to its ultimate performance very quickly. Not only does this allow for pre-training triage based on execution time, but it also allows for testing trained models “in real time” (integrated into the app or game, for example) after initial training to quickly identify problems with model quality or deficiencies in the training data.

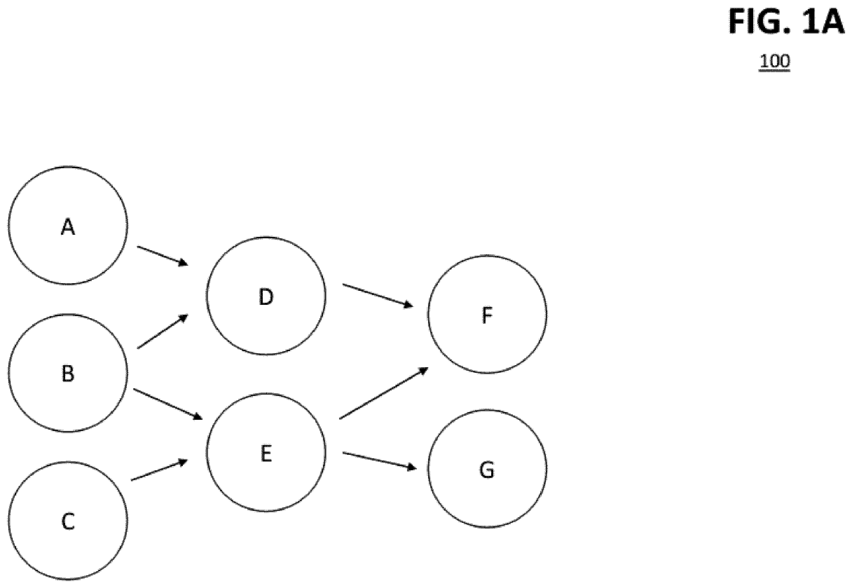

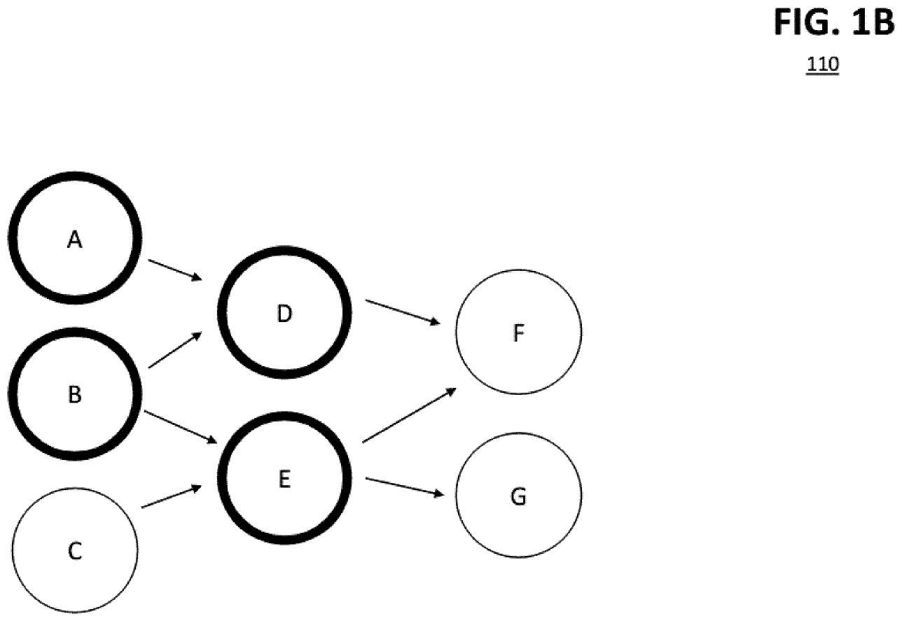

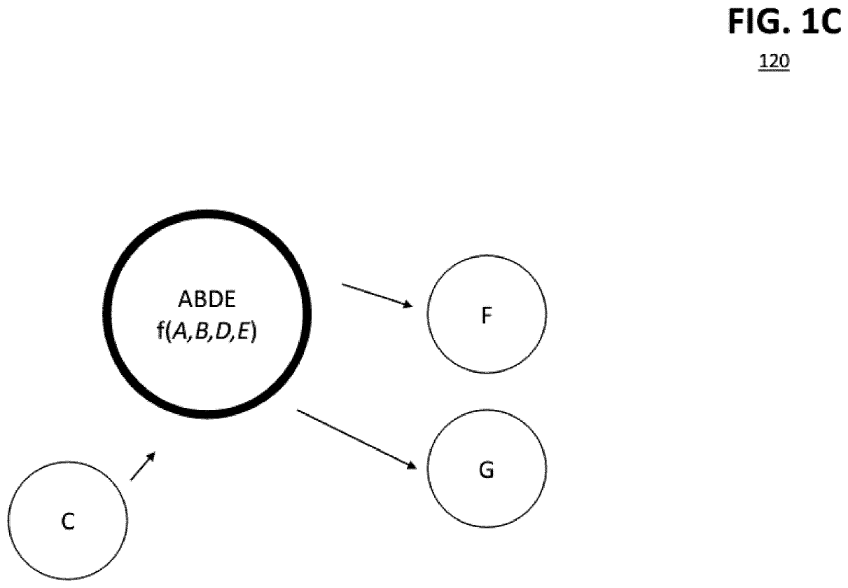

FIG. 1A is an illustration 100 of an example of a neural network including a plurality of kernels, in accordance with some embodiments of the present disclosure. The kernels include A, B, C, D, E, F, and G. The neural network may be structured such that the kernel D receives input from kernels A and B, and outputs to kernel F.

FIG. 1B is an illustration 110 of an example of a neural network including a first subset of a plurality of kernels, in accordance with some embodiments of the present disclosure. The processing circuitry may identify a first subset of kernels from the plurality of kernels in the neural network. For example, the subset may be kernels A, B, D, and E shown with bolded circumferences. The processing circuitry may then determine the characteristics of each respective kernel in the first subset. For example, each of kernels A, B, D, and E may perform operations that are amenable to a combination that generates greater efficiency. In the example of FIG. 1, the kernels A, B, D, and E have similar functions, although function similarity is not the only criterion by which kernels may be selected for combination.

FIG. 1C is an illustration 120 of an example of a neural network including a fused kernel, in accordance with some embodiments of the present disclosure. The dynamic rule set may be generated by processing circuitry based on a multiple of factors included pre-populated rules and dynamically generated rules based on the determined characteristics of the kernels. In response to the processing circuitry comparing the characteristics of the respective kernels in the first subset to the dynamic rule set, the processing circuitry identifies a second subset of the first subset based on the comparing, automatically generates instructions to combine the second subset of kernels, and updates the neural network based on the one or more instructions. For example, the subset of kernels A, B, D, and E are fused into a collection function shown as ABDE.

In some embodiments, the processing circuitry may identify a first subset of kernels from the plurality of kernels in the neural network by determining adjoining operations that can be fused. In some embodiments, this determination is repeated. In some embodiments, the processing circuitry may determine for graph-specific optimizations, that allow us to completely eliminate some processing steps (e.g. a concatenation operation may “join” two tensors along an axis by copying the two separate tensors to appropriate offsets in a single block of memory, and the processing circuitry may eliminate this by having the prior operations write the tensors into a previously allocated larger block of memory in one go). In some embodiments, the processing circuitry may look at triplets of operations (thought of as a prolog, main operation, and epilog, where the main operation is the most resource intensive part, and for which the prolog and epilog processing can be “swallowed up” almost unnoticed). In some embodiments, the processing circuitry may determine a natural subgraph split to reorder the data layout, or reduce the numerical precision to speed computation, without negatively impacting the quality of the overall results. In some embodiments, the processing circuitry may determine similarity of operations based on hardware-optimized computations. In some embodiments, the processing circuitry may select functions whose combination reduces the number of memory access operations performed. Because the hardware constrains our flexibility (while also providing the best opportunities for highest overall throughput), the processing circuitry may prioritize operations that are good matches for the underlying hardware, and then consider adjoining operations to be subservient (e.g. the hardware operation would be the computationally intense operation mentioned above, and the preceding and following operations would be considered the prolog and epilog).

In some embodiments, the processing circuitry may identify a first subset of kernels from the plurality of kernels in the neural network by preprocessing (fusing of layers)—UpscaleConcat and so on, which changes the graph itself. In some embodiments, the processing circuitry may runtime fusing/skipping of layers—skipping of Concatenation, fusing of BatchNorm with Convolution and so on, depending on runtime known conditions. In some embodiments, the processing circuitry may execute triplets of operations.

In some embodiments, the dynamic rule set may include a varying number of inputs. This is hard to handle efficiently in a library since looping across each input is less efficient (time-wise) than special case implementations for each input count, but having special cases for each possible input range is unwieldy in taking up space. Thus, the processing circuitry determines factors such as input count to be part of our dynamic rules system. There are also many special cases to consider (such as when a set of computations happens to fit perfectly within hardware resource limits—“just by luck”—and the processing circuitry designates that set of operations run well, or when the problem is just slightly misaligned from the hardware model, and no matter what, it will run inefficiently). The processing circuitry may allow for “static rules” that can override the more generic dynamic rules to allow for special cases to be treated in a special manner, without losing the power of the dynamic rules, which tend to be more general. The processing circuitry may use pattern detection algorithms that are most ripe for optimization, come up with logic to build the general optimized solution, then add the corresponding rule(s) to a viable set to consider. However, for any given circumstance, the “best” rule may vary even for the same network model. For example, in one case the processing circuitry may have limited memory and can only apply rules that keep the memory footprint small, whereas for another case, the processing circuitry may have enough memory available to precompute more steps and save the results for longer. This can vary based on destination hardware, or based on the needs of a host application when the computation graph will be only one of many computations the host application will be executing. In some embodiments, the processing circuitry may perform the optimization during generation of the neural network compute graph. In other embodiments, the processing circuitry may perform the optimization for an existing neural network compute graph.

In some embodiments, the processing circuitry may identify the operations that are most tightly tied to the optimal hardware execution path, and then look and the pre- and post-operations. This is often fairly isolated, but there could be some ambiguity, such as when the epilog of operation 1 is the same as the prolog for operation 2. When this happens, the processing circuitry may determine which fusing options are best (and for now, it is almost always that epilog fusing dominates prolog fusing). This may be a heuristic that tends to be true with regard to how the processing circuitry has implemented the current version of code.

In some embodiments, processing circuitry may build a library of source code templates to handle the programming of specialized hardware (e.g. tensor cores) along with a library of source code “options” that can be used in conjunction with the templates in order to create source code for custom fused kernels. This provides the re-use and amortization benefits of the library embodiment, while also providing many of the benefits of the manual fusing option (since fusing the specialized processing code with the available options yields custom fused kernels optimized for a particular network model.

In some embodiments, processing circuitry may create on-the-fly source code for layer operations that don't involve specialized compute hardware. This code is “bespoke”, in that it is created to optimize a precise series of operations found in a given model, but because it is isolated from the challenges related to the use of specialized hardware, this code creation can be automated, thereby achieving some of the benefits of both the manual fusing and tensor compilation approaches.

In some embodiments, processing circuitry may build a computation graph analysis system that analyzes the data flow through a model, then apply “fusing rules” to compile the model into a series of auto-generated fused kernels by leveraging the technologies described herein. This allows us to achieve many of the benefits of a tensor compilation approach, while still recognizing common layer patterns and leveraging prebuilt and tested subcomponents for kernel construction. It is in this step where the processing circuitry arranges execution to minimize memory fetches and stores (which increases execution speed while also reducing power consumption and allowing the model to run using less memory). This approach not only allows for the automated creation of model-specific optimized kernels, it also opens up dramatically more productive workflows for model design and broader problem-domain integration.

In some embodiments, processing circuitry may build a model to be used in performance-sensitive environments (e.g. anti-aliasing within a game, interactive artistic control within a content creation app, or object tracking for use in a self-driving car), it is important to make sure the model can execute within a well-defined “time budget”. Indeed, models that take too long to execute are simply “worthless” in this scenario, even if their “quality” is excellent with respect to other metrics. Thus, it is important to know how long it will take for a particular model to run before investing a lot of time training and tuning the model for quality. This is not possible to do efficiently today: The pre-generated library (e.g., pre-populated rule sets) option does not provide enough performance for proper triage, the manual fusing option involves a high investment in time and effort to “speed up” models that may not be able to achieve sufficient quality, and a tensor compilation option is not yet mature enough to optimize total model performance.

In some embodiments, the processing circuitry may deploy the model in an execution environment that differs from the development environment. For example, a game may need the model to execute in a DirectX environment, a content creation app may use a CUDA environment, and models for self-driving vehicles run on embedded hardware.

In some embodiments, the processing circuitry may generate stand-alone fused kernels, our approach allows for deployment in a broad range of environments, whereas other approaches may have limitations (e.g. using specific models may rule out execution in a DirectX or Vulkan environment).

In some embodiments, the processing circuitry may provide custom optimization to the neural network computing graph. For particularly important networks (e.g. DLSS), the processing circuitry may customize kernel operations to eke out the small amount of additional performance benefits that automation isn't yet able to achieve. This would normally be undertaken after all other aspects of the iterative development process have been completed. In one implementation, the processing circuitry extends the fusing rules used during code generation to favor whatever hand-tuned kernels are available, and automates the “assembly” of model-specific kernels, where some may be manually-written and others are auto-generated.

In some embodiments, the processing circuitry may switch from runtime compilation to offline compilation at any point. The offline compilation may have access to updated kernel compiler technology or advanced extension or control methods that can be used to generate more highly-optimized kernels.

In some embodiments, the processing circuitry may implement tight coupling with compute graph optimization techniques. In one embodiment, the processing circuitry may remove Batch Norm from a Convolution-BatchNorm sequence (where the shift and scale related to the Batch Norm layer can be pre-applied to the weights for the Convolution layer, thereby eliminating the need to process Batch Norm separately. In another embodiment, the processing circuitry may remove Concat on the channel axis when using NCHW layout (or for the H axis with NHWC layout) by allocating a larger memory block for the concatenated tensor output, and having prior layers write their output to the proper offset of this larger buffer. In yet another embodiment, the processing circuitry may minimize memory footprint by reusing intermediate memory blocks in an efficient fashion. In yet even another embodiment, the processing circuitry may minimize graph traversal during inference by caching intermediate values for subgraphs that haven't changed from the previous inference run.

In some embodiments, the processing circuitry may implement generation of custom kernels to the graph analysis and traversal logic. This may have the effect of opening up additional model-specific optimization options. In one embodiment, the processing circuitry may remove Concat across the channel axis even when the layout is NHWC by having the layers feeding Concat write out their data using a “stride and skip” pattern that naturally interleaves output from the various input layers into a preallocated larger buffer. In another embodiment, the processing circuitry may reduce memory footprint and memory bandwidth constraints for some skip connections by using custom reduced precision formats (e.g. “fp8” variants) as outputs from the skip-source layers matched with inputs from the skip-sink layers. The above techniques implemented by processing circuitry of natural coupling of graph analysis and kernel generation leads to optimizations that cannot be created with other methods commonly used today. Plus, these optimizations can also be automated and performed dynamically, so the benefits will also be available early in the design and model evaluation development process.

The processing circuitry may implement the general fusing and kernel optimizations (i.e. not involving Tensor Cores) that may be accomplished by generating kernel source code within layer classes.

In some embodiments, the processing circuitry may separate out the “rapid development” stage (where kernels are dynamically compiled using NVRTC only for the GPU on the developer's machine) from the “deployment” stage (where kernels are compiled for a range of GPU devices, and saved to disk along with a compiled form of the model execution graph). The processing circuitry may implement a CUDA development system during the model design phase, but even the CUDA runtime is not needed for deployment (unless the network is running in a CUDA-based application).

Another implementation of the disclosed systems and methods herein provide for dynamically updating a neural network comprising a plurality of kernels for a hardware resource. Processing circuitry may be implemented to identify a first subset of kernels from the plurality of kernels in the neural network for a hardware resource (e.g., an amount of memory required for operations for a set of kernels of a compute graph in a neural network). The processing circuitry may then determine the characteristics of each respective kernel in the first subset. The processing circuitry may then determine a hardware resource level of the hardware resource based on the identified first subset of kernels. For example, the processing circuitry may calculate requisition of 400 kilobytes of memory of cache to perform the operations in the first subset of kernels. In this scenario, the processing circuitry may allocate this amount of memory for the operations. The processing circuitry may then compare the characteristics of the respective kernels in the first subject to a dynamic rule set. In response to the processing circuitry comparing the characteristics of the respective kernels in the first subset to the dynamic rule set, the processing circuitry identifies a second subset of the first subset based on the comparing, automatically generates instructions to combine the second subset of kernels, and updates the neural network based on the one or more instructions. The processing circuitry may then adjust the hardware resource level based on the updated neural network. For example, if the compute graph of the neural network is simplified then memory allocation may be less (e.g., the system may only need 300 kilobytes of cache). In this scenario, the processing circuitry may reduce the cache from 400 to 300 based on the adjusted compute graph of the neural network.

In some embodiments, various types of hardware resources may be allocated on a basis consistent with the dynamically updated neural network. The types of hardware resources include, but are not limited to, memory, processing circuitry, graphical processing unit circuitry, cache, discrete processing modules (e.g., Deep Learning Accelerators, etc.), hard disk space, and other hardware resources.

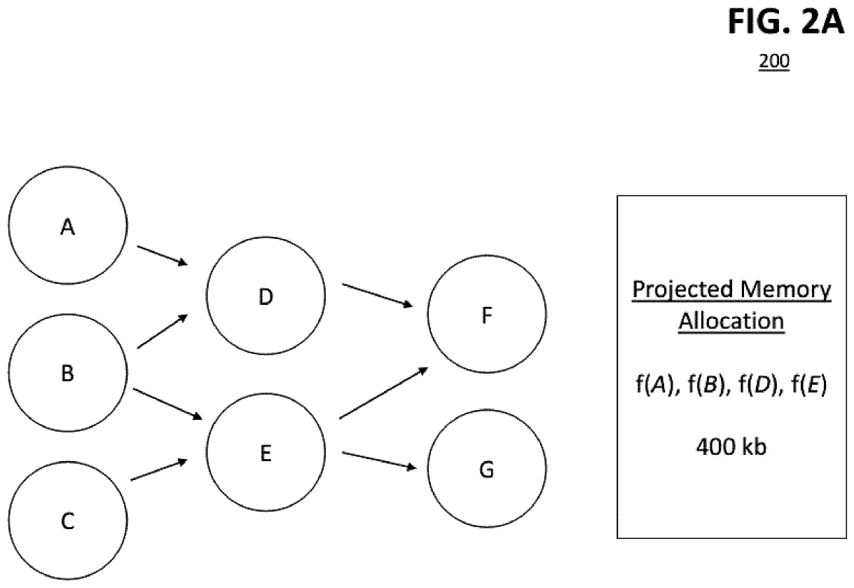

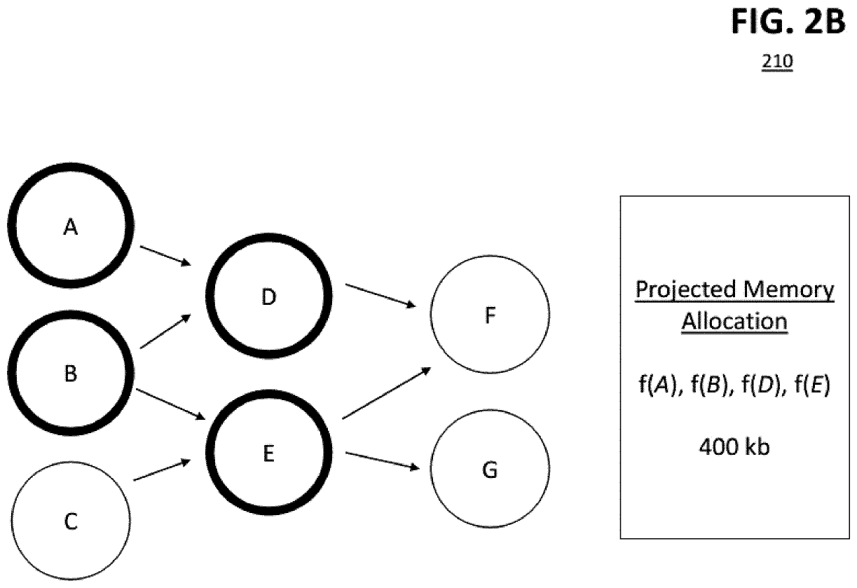

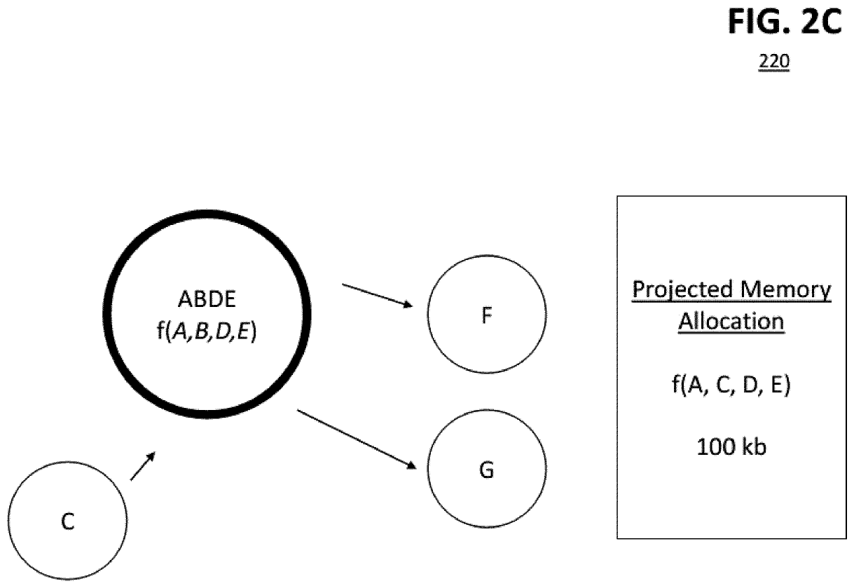

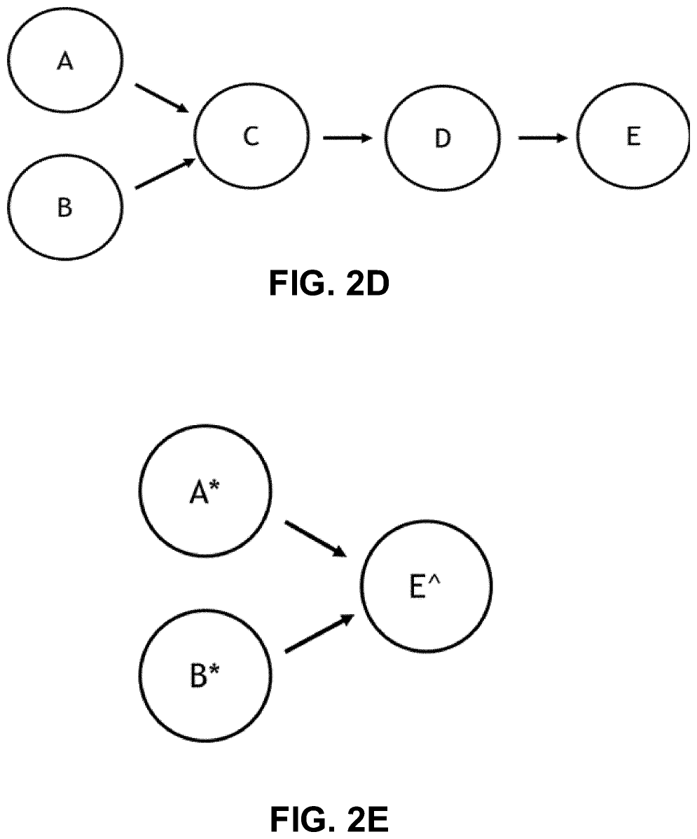

FIG. 2A is an illustration 200 of an example of a neural network including a plurality of kernels and corresponding hardware resource value, in accordance with some embodiments of the present disclosure. The kernels include A, B, C, D, E, F, and G. The neural network may be structured such that the kernel E receives input from kernels B and C, and outputs to kernels F and G. A projected memory allocation for this set of kernel operations is 400 kb.

FIG. 2B is an illustration 210 of an example of a neural network including a first subset of a plurality of kernels and corresponding hardware resource value, in accordance with some embodiments of the present disclosure. The processing circuitry may identify a first subset of kernels from the plurality of kernels in the neural network. For example, the subset may be kernels B, C, D, and E shown with bolded circumferences. The processing circuitry may then determine the characteristics of each respective kernel in the first subset. For example, each of kernels B, C, D, and E may have similar functions, or may otherwise have any functions which are amenable to combination in a manner that increases computational efficiency, e.g., results in increased speed, reduced energy consumption, or the like. A projected memory allocation for this set of kernel operations is 400 kb.

FIG. 2C is an illustration 220 of an example of a neural network including a fused kernel and corresponding hardware resource value, in accordance with some embodiments of the present disclosure. The dynamic rule set may be generated by processing circuitry based on a multiple of factors included pre-populated rules and dynamically generated rules based on the determined characteristics of the kernels. In response to the processing circuitry comparing the characteristics of the respective kernels in the first subset to the dynamic rule set, the processing circuitry identifies a second subset of the first subset based on the comparing, automatically generates instructions to combine the second subset of kernels, and updates the neural network based on the one or more instructions. For example, the subset of kernels B, C, D, and E are fused into a collection function shown as BCDE. A projected memory allocation for this set of kernel operations is 100 kb.

In some embodiments, some network graphs can be split in a parallel fashion, meaning that certain subgraph regions could be run in parallel on multiple GPUs, hence finishing much faster. But based on a particular deployment, the processing circuitry may reserve some GPUs for other uses, and that may happen on a dynamic basis so the problem can't be fully resolved in a static manner. In this case entire GPUs are considered dynamic resources.

In some embodiments, the processing circuitry may implement a dynamic memory allocation scheme that reuses memory blocks when all references to them have been resolved. This automatically allows for dynamic rebalancing and efficient reuse, especially because the nature of DL model graphs is that the memory blocks tend to be quite large (and relatively low in number), so memory fragmentation and other problems common in, say, languages using garbage collection with lots of small dynamic allocations are not as relevant here. In some embodiments, the processing circuitry may make several passes through the computation graph using just a subset of the full input on each path so as to keep the footprint small, where the multi-pass approach also then incurs the extra overhead of stitching together the output fragments once all passes have finished (or incrementally as they complete). In some embodiments, the processing circuitry may alter the algorithm. For example, convolutions computed using the Winograd algorithm uses memory to precompute some partial results, with those results saved to speed up future applications of this convolution layer. The Implicit precompute GEMM algorithm doesn't perform this precompute-and-save step, so its footprint is smaller, but for the case where Winograd shines, IPG is slower. Fusing rules implemented by the processing circuitry may be used to influence which type of convolution algorithm is best for a particular deployment.

Another implementation of the disclosed systems and methods herein provide for inspecting a network location before and after dynamically updating a neural network comprising a plurality of kernels. Processing circuitry may be implemented to inspect a dynamically updated neural network comprising a plurality of kernels. The processing circuitry may identify a first subset of kernels from the plurality of kernels. The processing circuitry may then determine the characteristics of each respective kernel in the first subset. The processing circuitry may then compare the characteristics of the respective kernels in the first subject to a dynamic rule set. In response to the processing circuitry comparing the characteristics of the respective kernels in the first subset to the dynamic rule set, the processing circuitry identifies a second subset of the first subset based on the comparing, automatically generates instructions to combine the second subset of kernels, and updates the neural network based on the one or more instructions. The processing circuitry may then, in response to updating the neural network, inspect a specific network location. The specific network location may be located away from a network location of the second subset. For example, an analytics probe may be implemented via control circuitry to monitor computing operations at a specific location in the neural network which is not at the location of the compute graph proximate to the second subset. In this way, the processing circuitry may analyze results before and after instructions have been sent to dynamically update the neural network.

FIGS. 2D-2E illustrate a further example of kernel combination. FIG. 2D is an illustration of an example of a neural network including a plurality of kernels, in accordance with some embodiments of the present disclosure. In this example, nodes A and B may perform certain tensor functions, and node C may perform a concatenation function concatenating the tensor outputs of A and B along a specified axis. Node D may perform a pointwise operation on the elements of the concatenated tensor output of C (e.g., multiplication of each tensor element by a constant, a min(0, x) function finding the smallest tensor element, or the like), and pass the resulting tensor to node E. The node arrangement of FIG. 2D requires a significant number of operations, some of which are costly in terms of time and energy required. In particular, the results of A and B must each be stored in memory such as register memory (if large enough to hold these results), or memory located outside the chip containing the computation logic, and retrieved or fetched by C. Node C must then write the concatenated tensor to memory again, where it is fetched by D. After D performs its pointwise operations, it then writes the resulting tensor to memory again, where it is read in by E. This results in a total of four write operations and three read operations (seven total memory access operations), each of which is slow and entails significant energy cost.

In embodiments of the disclosure, the node configuration of FIG. 2D may be fused as shown in FIG. 2E. More specifically, the function of nodes A and B may each be combined with the pointwise operation of node C to produce nodes A* and B* that each perform the respective tensor functions of A and B, plus the pointwise operation of C. Prior to performance of the functions of A* and B*, memory space such as register memory is allocated for the concatenated tensor, so that A* and B* each perform their tensor operations and their pointwise operation, and write the results to the appropriate portion of the allocated memory. Node E remains the same as node E of FIG. 2D, and is designated differently mainly because its preceding functions have changed. This fused configuration requires fewer memory access operations, and is thus faster and more efficient. More specifically, nodes A* and B* write their output to the allocated memory space, for retrieval by E\hat{ }. This results in a total of two write operations and one read operation (three total memory access operations), significantly reducing the time and energy cost of processing as compared to the configuration of FIG. 2D.

Node combination according to embodiments of the disclosure may be performed for any node types or functions, so as to reduce the time and energy cost associated with any neural network or machine learning model. That is, embodiments of the disclosure may seek to combine nodes having any functions. For example, convolution nodes and max pooling nodes may be fused. In this manner, the fused node(s) would actually increase processing speed over convolution alone, as the pooling operation results in writing only a fraction (typically one quarter) of the convolution output to memory. This saves significant memory access operations as compared to separate convolution and pooling nodes which would write the entire convolution output to memory, followed by retrieval of the entire convolution output by the pooling node. Embodiments of the disclosure may identify and combine any functions, presented in any order, to produce more efficient processing of machine learning models.

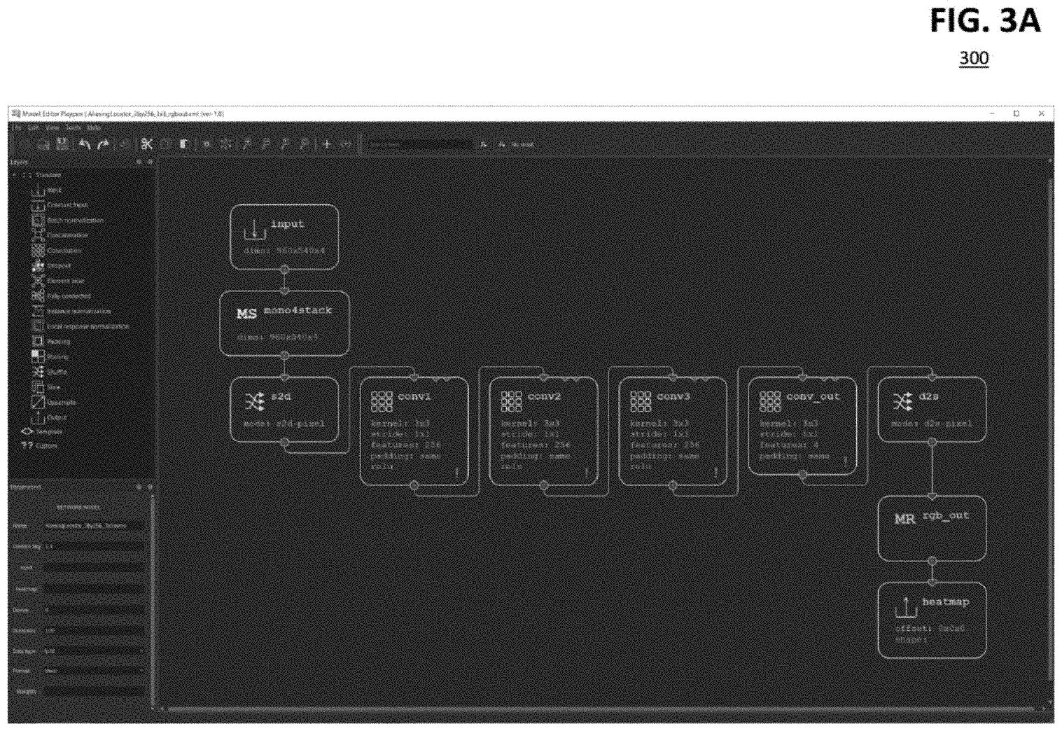

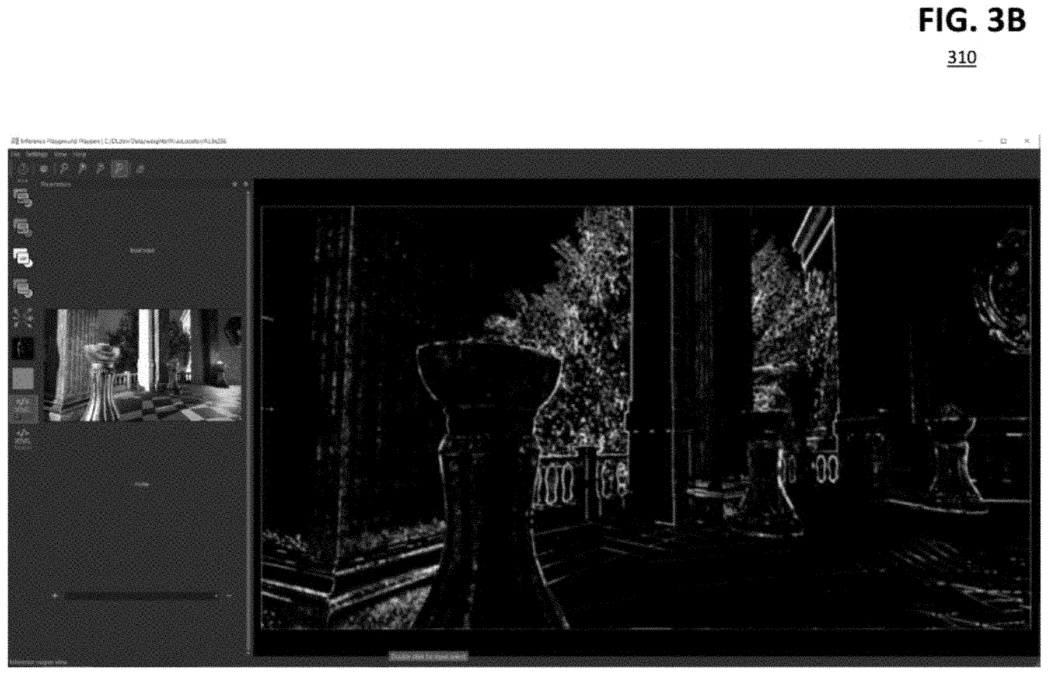

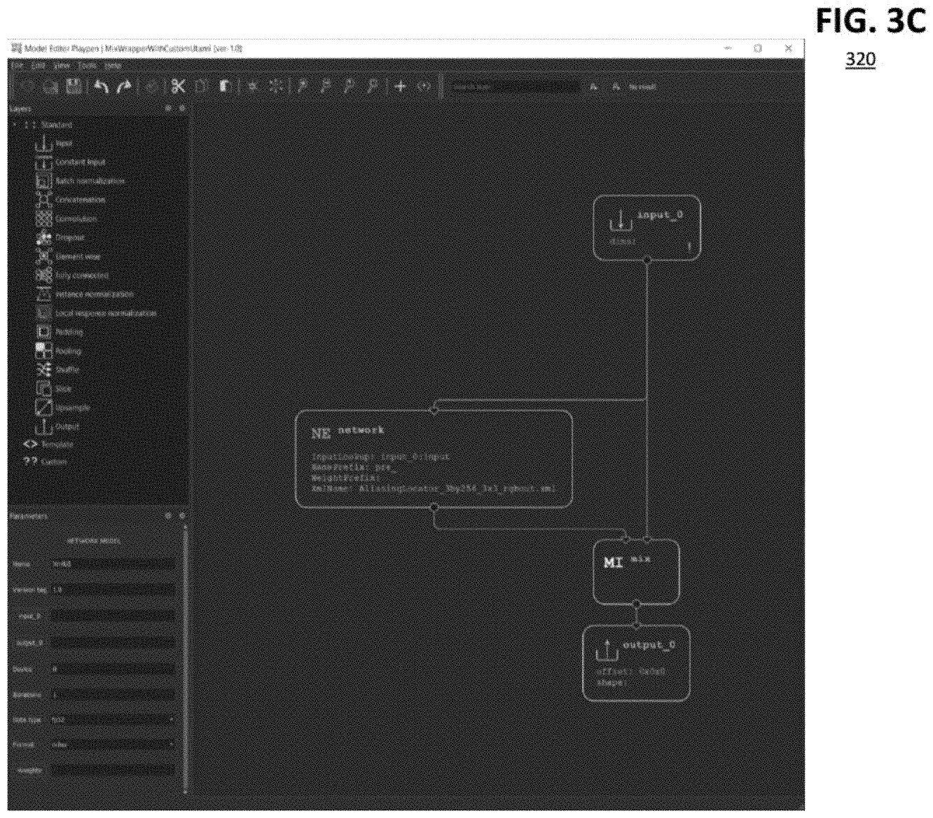

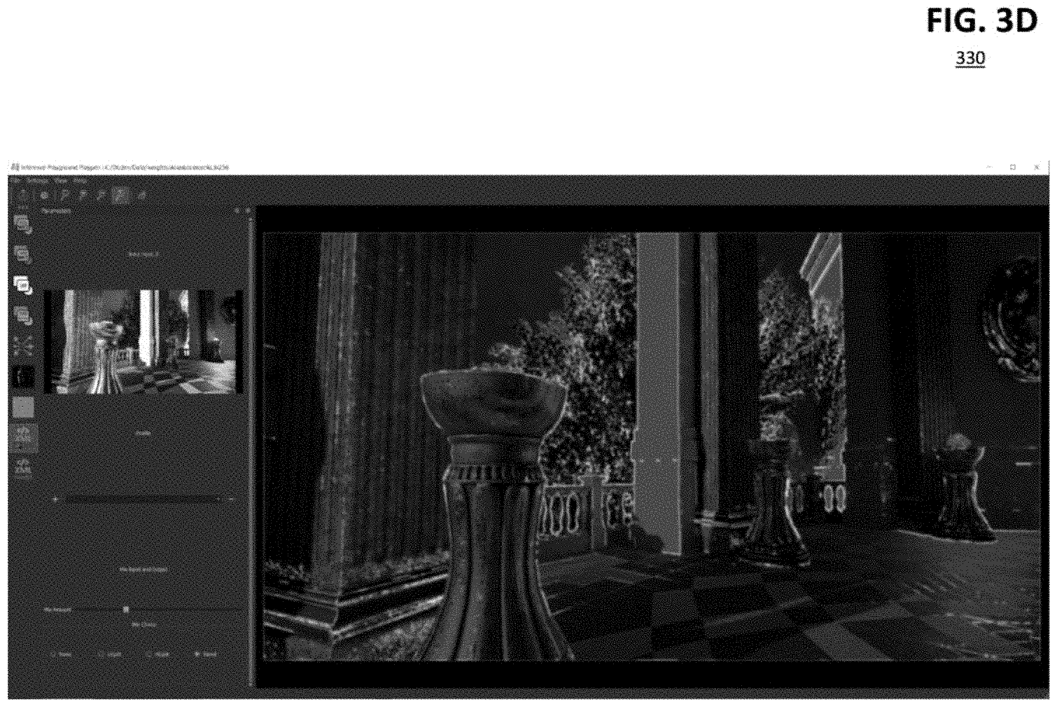

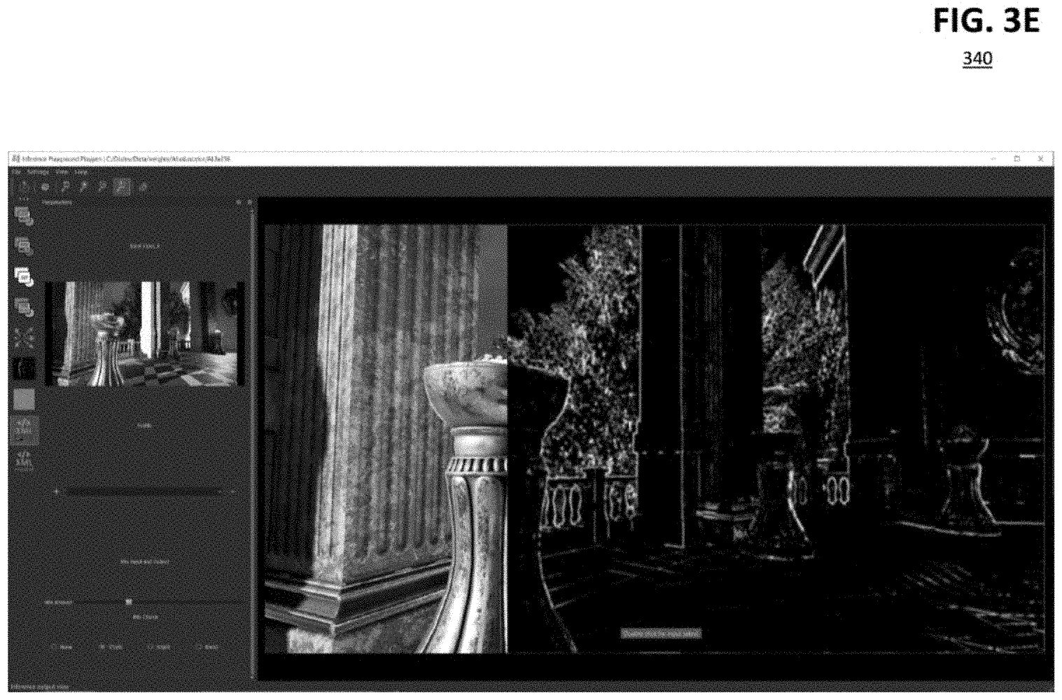

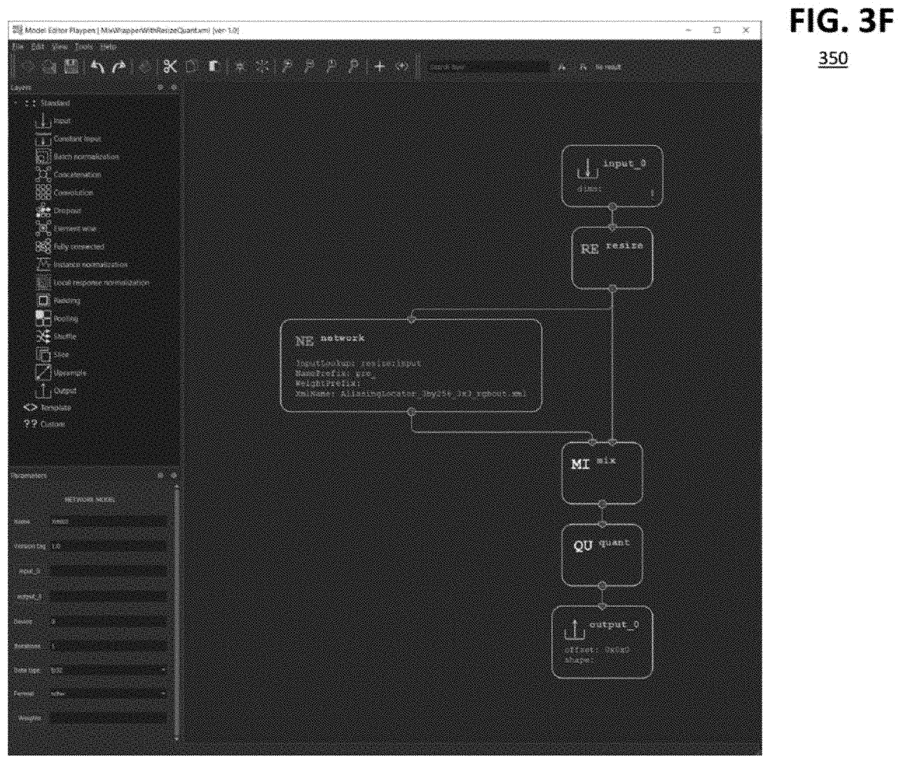

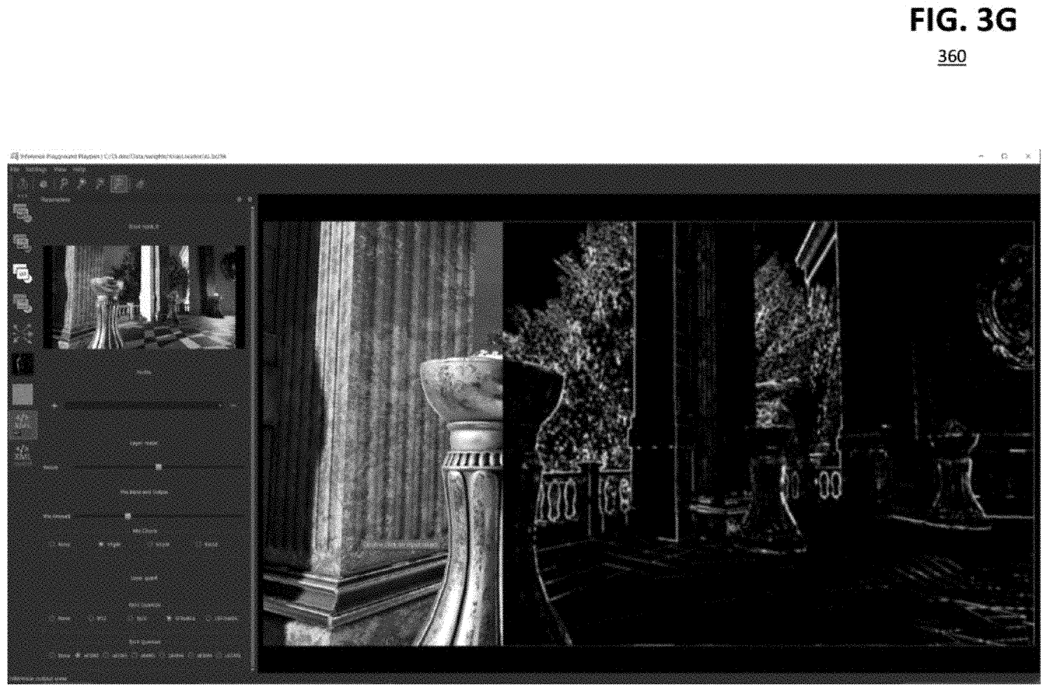

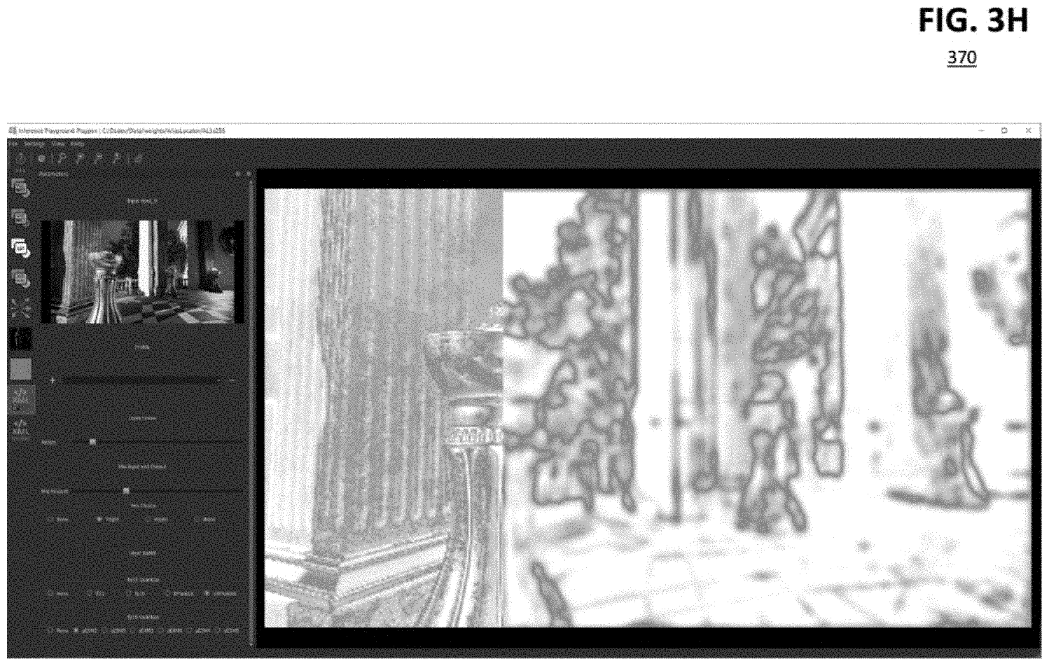

FIG. 3A is an illustration 300 of an example of a generated neural network flow diagram for detecting aliasing in a graphical output, in accordance with some embodiments of the present disclosure. The processing circuitry may generate a neural network that detects “jaggies” (spatially aliased edges) in computer-generated imagery. The generated network, by processing circuitry, receives an image as input, and generates a monochrome “heatmap” as output. The white in the heatmap indicates where jaggies are detected, and black indicates no jaggies are found. Shades of gray indicate levels of confidence (so, dark gray means the network thinks maybe just a few jaggies may be present, and close to white means that it is very confident jaggies are there). In FIG. 3A there are a plurality of convolutional neural networks (e.g., conv1, conv2, conv3, and conv_out) and other neural network components.

FIG. 3B is an illustration 310 of an example of a generated heatmap based on an input image to a neural network, in accordance with some embodiments of the present disclosure. The processing circuitry may generate a neural network that detects the input image is on the left while the heatmap is displayed on the right.

FIG. 3C is an illustration 330 of an example of adding an analysis layer to the neural network, in accordance with some embodiments of the present disclosure. The processing circuitry may implement an analysis layer in the neural network to mix the input and output kernels.

FIG. 3D is an illustration 340 of an example of mixing the input and output kernels in the neural network, in accordance with some embodiments of the present disclosure. The processing circuitry may adjust the mixing based on a slider in a graphical user interface as shown in FIG. 3D.

FIG. 3E is an illustration 350 of an example of alteration of the graphical user interface based on the neural network, in accordance with some embodiments of the present disclosure. The processing circuitry may adjust the graphical user interface by providing a vertical split between the input and heatmap (obtained just by changing the UI controls as shown in FIG. 3E.

FIG. 3F is an illustration 360 of an example of quantizing the output of the kernels of the neural network to a lower-precision numerical format, in accordance with some embodiments of the present disclosure. The processing circuitry may quantize the output to a lower-precision numerical format, or resize the input image before looking for jaggies by using this larger network controls as shown in FIG. 3F.

FIG. 3G is an illustration 370 of an example of a modified graphical user interface based on quantizing the output of the kernels of the neural network to a lower-precision numerical format, in accordance with some embodiments of the present disclosure. The processing circuitry may provide additional controls for the graphical user interface to modify the output kernels of the neural network to a lower-precision numerical format, or resize the input image before looking for jaggies by using this larger network controls as shown in FIG. 3G.

FIG. 3H is an illustration 380 of an example of a modified neural network based on a reduced size input kernel, in accordance with some embodiments of the present disclosure. The processing circuitry may receive a reduced size/precision of input image. The processing circuitry may then implement unsigned BFloat32 quantization as shown in FIG. 3H.

In some embodiments, the processing circuitry may select point of interests in the computational graph to determine a reaction of network on impact in a particular tensor area.

In some embodiments, the processing circuitry may alter the computation graph to include “analysis” nodes (or layers) that can be used to stress various aspects of the network and automatically evaluate the effects.

In some embodiments, the processing circuitry may add specially designed nodes to the computation graph that can be dynamically enabled or disabled. When enabled, some of these nodes can alter tensor values dynamically whereas others are designed to measure responses to the stimulation or capture data via manual or automatic triggers. Since DL network models are already (usually) built by connecting pre-built “layers” to form a computation graph, the process of adding analysis layers to a model matches the standard workflow already used by practitioners today, while easily providing a way to gather dynamic data regarding model performance. This is useful during early model design, later model tuning, pre-deployment model validation, or even in-field verification of continued accuracy.

For example, noise (or other type of sensor degradation) can be simulated at a network input node (in a dynamic, time varying fashion), and a “snapshot” or other type of comparison layer can be used to check for stability of results at a later point in the network. More generally, other types of problems (missing sensor input, out of range values, quantization errors, reduced processing speed, etc.) can be simulated at any node of the computation graph—this approach is not limited to only examining inputs and outputs to the full DL model. In fact, during network design, this technique can be used to measure whether “bad” signals are amplified or attenuated, and to what degree. A dynamic analysis of a trained network is better than a static analysis of an abstract network, since nonlinearity in the trained network can cause hard-to-predict behavior. This can go both directions: training can result in theoretically bad situations being mathematically eliminated from the fully-trained model, or in theoretically OK situations becoming problematic due to numerical precision limitations.

In some embodiments, the processing circuitry may dynamically enable and disable analysis/validation nodes in a deployed model in such a manner that they literally have no overhead when disabled (by having their inputs redirected to the input of the subsequent layer, thereby excising them completely from the inference computation). This could, for example, allow for full-speed inference execution when a piece of equipment is in use, while still allowing for in-field validation checks whenever the equipment is turned on, or manually triggered when any system updates occur.

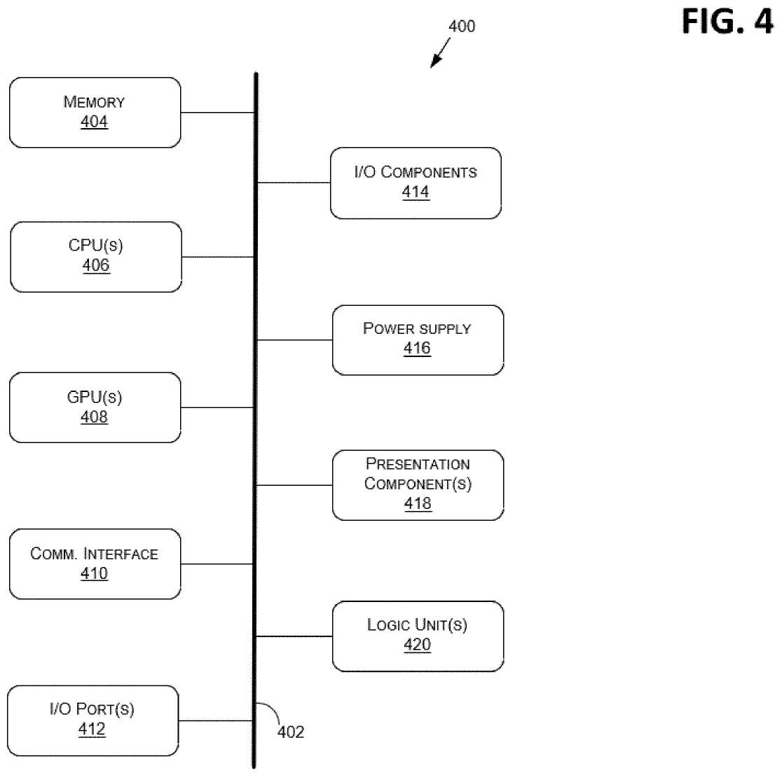

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, I/O ports 412, input/output components 414, a power supply 416, one or more presentation components 418 (e.g., display(s)), and one or more logic units 420. The computing device 400 may be implemented to perform systems and methods are described herein for dynamically updating a neural network having a plurality of kernels.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point, connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. The CPU(s) 406 and/or the GPU(s) 408, the logic unit(s) 420, alone, or in combination, may be referred to as processing circuitry. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), I/O elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, including wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 412 may enable the computing device 400 to be logically coupled to other devices including the I/O components 414, the presentation component(s) 418, and/or other components, some of which may be built into (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

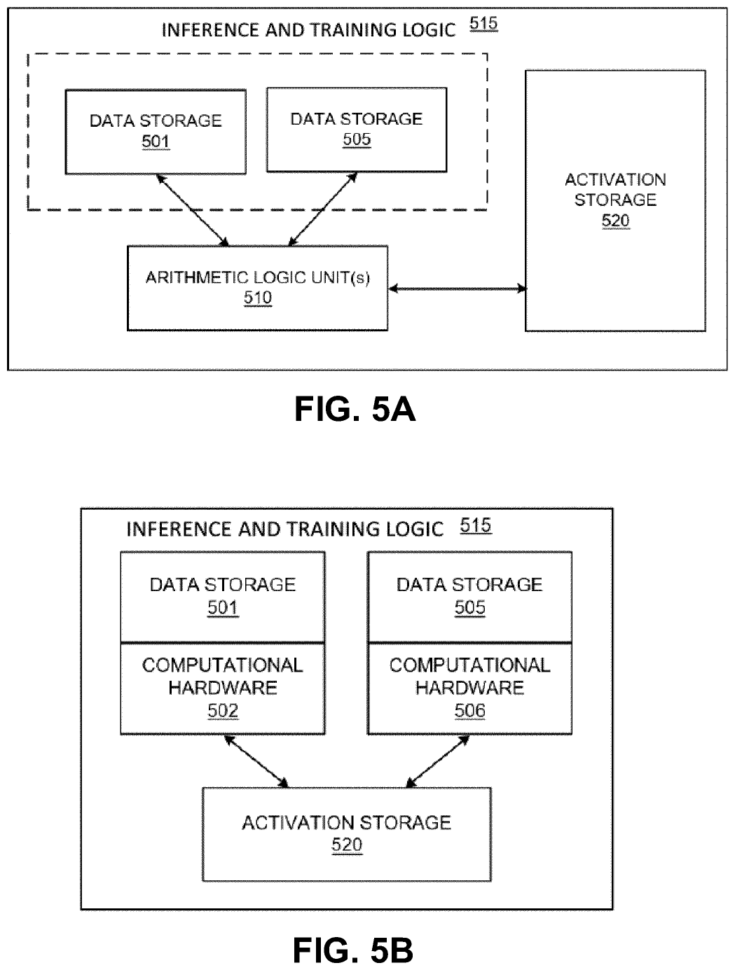

FIG. 5A illustrates inference and/or training logic 515 used to perform inferencing and/or training operations associated with one or more embodiments. Details regarding inference and/or training logic 515 are provided below in conjunction with FIGS. 5A and/or 5B.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to on one or more processors or other hardware logic devices or circuits. In at least one embodiment, code and/or data storage 505 may be cache memory, DRAM, SRAM, non-volatile memory (e.g., Flash memory), or other storage. In at least one embodiment, choice of whether code and/or data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be same storage structure. In at least one embodiment, code and/or data storage 501 and code and/or data storage 505 may be partially same storage structure and partially separate storage structures. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or data 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a coprocessor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, code and/or data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5.A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment various. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5.B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5.B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5.B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one “storage/computational pair 501/502” of code and/or data storage 501 and computational hardware 502 is provided as an input to next “storage/computational pair 505/506” of code and/or data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

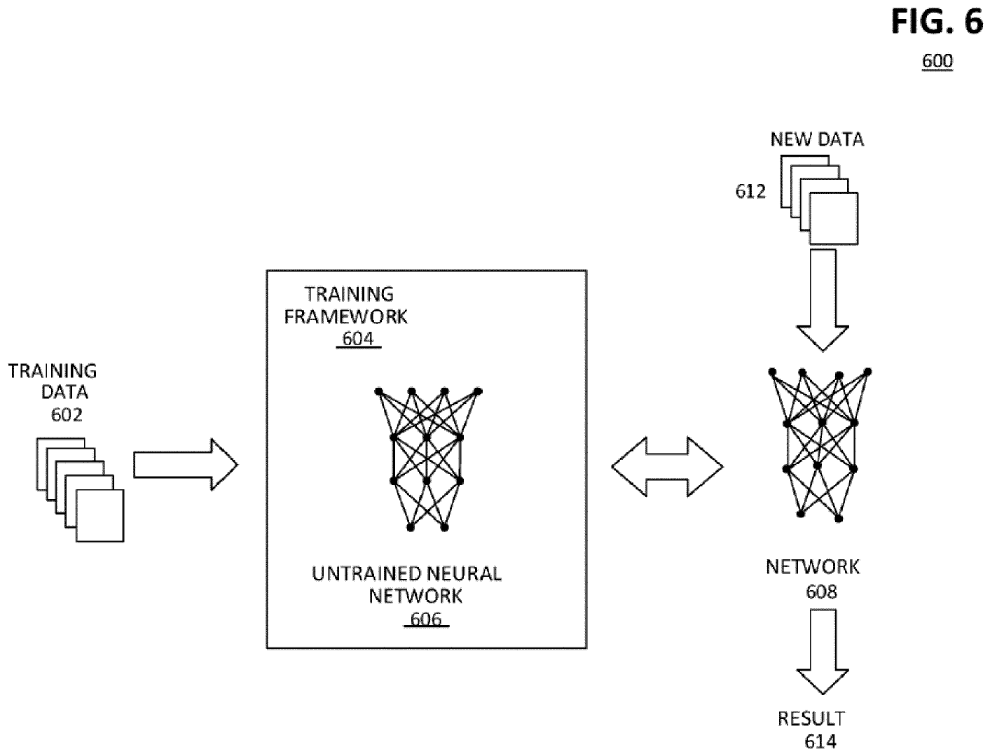

FIG. 6 illustrates training and deployment of a deep neural network, according to at least one embodiment. In at least one embodiment, untrained neural network 9606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

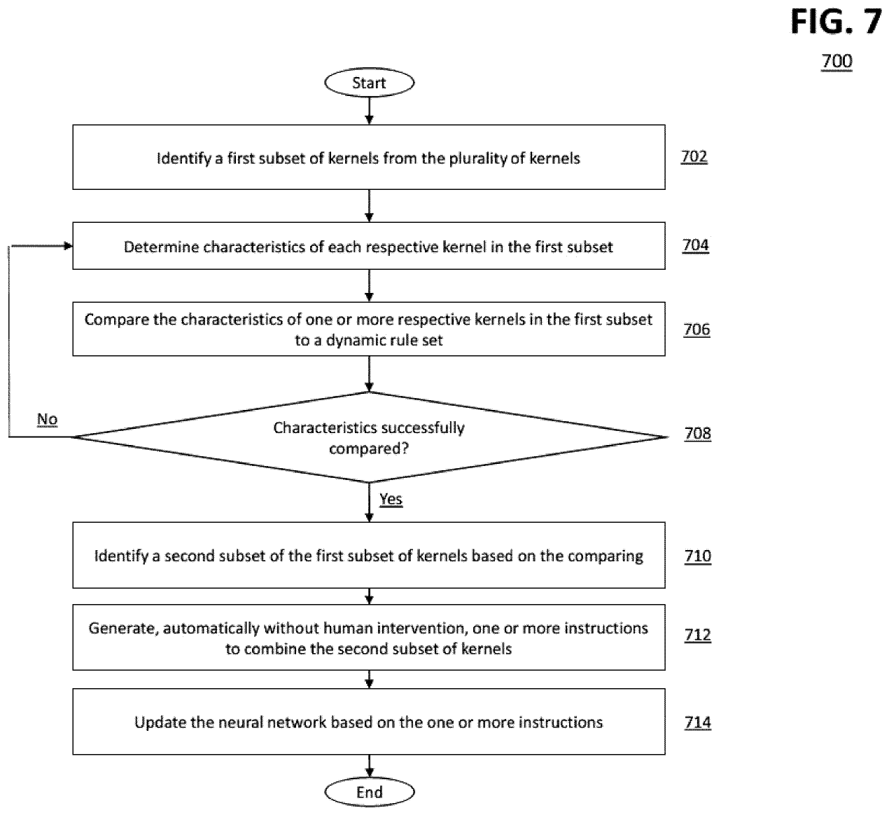

FIG. 7 is an example of an illustrative flowchart of dynamically updating a neural network comprising a plurality of kernels, in accordance with some embodiments of the present disclosure. Process 700, and any of the following processes, may be executed by processing circuitry. The CPU(s) 406 and/or the GPU(s) 408, the logic unit(s) 420, alone, or in combination, may be referred to as processing circuitry. In some embodiments, the processing circuitry may also include one or more hardware accelerators (e.g., DLA(s) and/or PLA(s)). Processing circuitry should be understood to mean circuitry based on one or more microprocessors, microcontrollers, digital signal processors, programmable logic devices, system on chip (SoC), field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units or multiple different processors. Any type and structure of processing circuitry may be employed. For example, processing circuitry may include a multi-core processor, a multi-core processor structured as a graphics or computation pipeline for carrying out operations in parallel, a neuromorphic processor, any other parallel processor or graphics processor, or the like. In at least one embodiment, processing circuitry may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor or graphics processor, for example.

Now referring to FIGS. 7-10, each block of methods described in FIGS. 7-9, described herein, comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. These methods may additionally or alternatively be executed by any one system, or any combination of systems, including, but not limited to, those described herein.

At 702, the processing circuitry (e.g., CPU 406, GPU 408, and/or Logic Units 420) identifies a first subset of kernels from the plurality of kernels. In some embodiments, the processing circuitry may, at least in part, utilize memory 404 to identify the first subset of kernels from the plurality of kernels. In some embodiments, processing circuitry may, at least in part, utilize I/O ports 412 to access other logic units and/or data structures to identify the first subset of kernels from the plurality of kernels.

At 704, the processing circuitry (e.g., CPU 406, GPU 408, and/or Logic Units 420) determines characteristics of each respective kernel in the first subset. In some embodiments, the processing circuitry may, at least in part, utilize memory 404 to determine the characteristics of each respective kernel in the first subset. In some embodiments, processing circuitry may, at least in part, utilize I/O ports 412 to access other logic units and/or data structures to determine the characteristics of each respective kernel in the first subset.

At 706, the processing circuitry (e.g., CPU 406, GPU 408, and/or Logic Units 420) compares the characteristics of one or more respective kernels in the first subset to a dynamic rule set. In some embodiments, the processing circuitry may, at least in part, utilize memory 404 to compare the characteristics of one or more respective kernels in the first subset to a dynamic rule set. In some embodiments, processing circuitry may, at least in part, utilize I/O ports 412 to compare the characteristics of one or more respective kernels in the first subset to a dynamic rule set.

At 708, the processing circuitry (e.g., CPU 406, GPU 408, and/or Logic Units 420) determines whether the characteristics of one or more respective kernels in the first subset and the dynamic rule set have been successfully compared. If, at 708, the characteristics of one or more respective kernels in the first subset and the dynamic rule set have not been successfully compared, the processing circuitry reverts to 704.

If, at 708, the characteristics of one or more respective kernels in the first subset and the dynamic rule set have been successfully compared, the processing circuitry advances to 710. At 710, the processing circuitry (e.g., CPU 406, GPU 408, and/or Logic Units 420) identifies a second subset of the first subset of kernels based on the comparing. In some embodiments, the processing circuitry may, at least in part, utilize memory 404 to identify a second subset of the first subset of kernels based on the comparing. In some embodiments, processing circuitry may, at least in part, utilize I/O ports 412 to identify a second subset of the first subset of kernels based on the comparing.

At 712, the processing circuitry (e.g., CPU 406, GPU 408, and/or Logic Units 420) generates, automatically without human intervention, one or more instructions to combine the second subset of kernels. In some embodiments, the processing circuitry may, at least in part, utilize memory 404 to generate, automatically without human intervention, one or more instructions to combine the second subset of kernels. In some embodiments, processing circuitry may, at least in part, utilize I/O ports 412 to generate, automatically without human intervention, one or more instructions to combine the second subset of kernels.

At 714, the processing circuitry (e.g., CPU 406, GPU 408, and/or Logic Units 420) updates the neural network based on the one or more instructions. In some embodiments, the processing circuitry may, at least in part, utilize memory 404 to update the neural network based on the one or more instructions. In some embodiments, processing circuitry may, at least in part, utilize I/O ports 412 to update the neural network based on the one or more instructions.

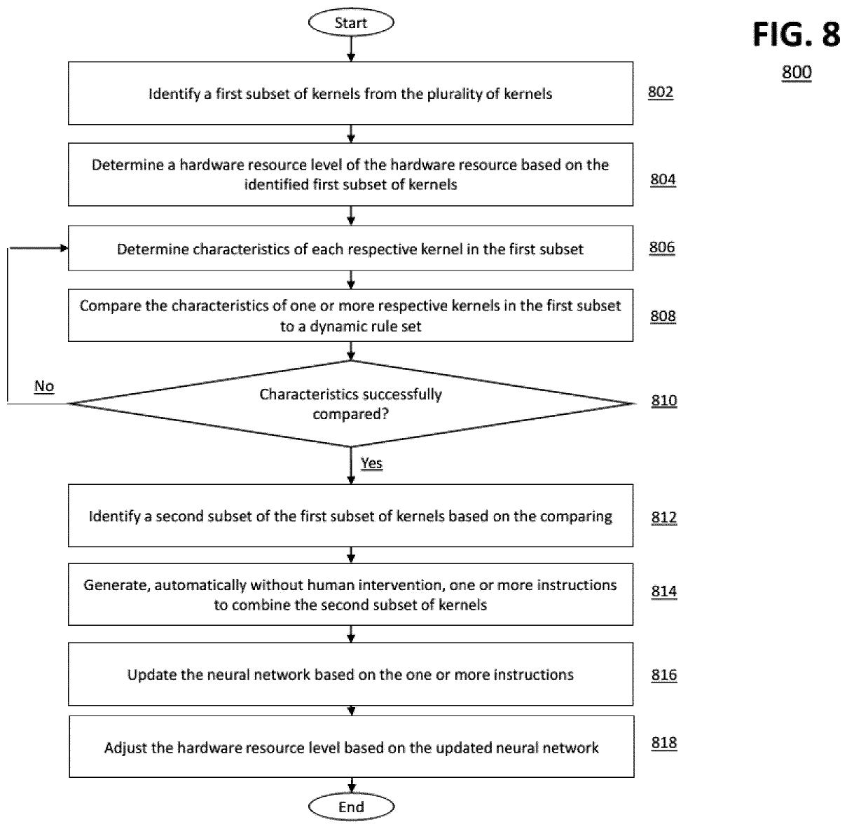

FIG. 8 is an example of an illustrative flowchart 800 of dynamically updating a neural network comprising a plurality of kernels for a hardware resource, in accordance with some embodiments of the present disclosure. At 802, the processing circuitry (e.g., CPU 406, GPU 408, and/or Logic Units 420) identifies a first subset of kernels from the plurality of kernels. In some embodiments, the processing circuitry may, at least in part, utilize memory 404 to identify the first subset of kernels from the plurality of kernels. In some embodiments, processing circuitry may, at least in part, utilize I/O ports 412 to access other logic units and/or data structures to identify the first subset of kernels from the plurality of kernels.

At 804, the processing circuitry (e.g., CPU 406, GPU 408, and/or Logic Units 420) determines a hardware resource level of the hardware resource based on the identified first subset of kernels. In some embodiments, the processing circuitry may, at least in part, utilize memory 404 to determine a hardware resource level of the hardware resource based on the identified first subset of kernels. In some embodiments, processing circuitry may, at least in part, utilize I/O ports 412 to determine a hardware resource level of the hardware resource based on the identified first subset of kernels. In some embodiments, the processing circuitry may, at least in part, utilize I/O components 414 to determine a hardware resource level of the hardware resource based on the identified first subset of kernels.

At 806, the processing circuitry (e.g., CPU 406, GPU 408, and/or Logic Units 420) determines characteristics of each respective kernel in the first subset. In some embodiments, the processing circuitry may, at least in part, utilize memory 404 to determine the characteristics of each respective kernel in the first subset. In some embodiments, processing circuitry may, at least in part, utilize I/O ports 412 to access other logic units and/or data structures to determine the characteristics of each respective kernel in the first subset.

At 808, the processing circuitry (e.g., CPU 406, GPU 408, and/or Logic Units 420) compares the characteristics of one or more respective kernels in the first subset to a dynamic rule set. In some embodiments, the processing circuitry may, at least in part, utilize memory 404 to compare the characteristics of one or more respective kernels in the first subset to a dynamic rule set. In some embodiments, processing circuitry may, at least in part, utilize I/O ports 412 to compare the characteristics of one or more respective kernels in the first subset to a dynamic rule set.

At 810, the processing circuitry (e.g., CPU 406, GPU 408, and/or Logic Units 420) determines whether the characteristics of one or more respective kernels in the first subset and the dynamic rule set have been successfully compared. If, at 810, the characteristics of one or more respective kernels in the first subset and the dynamic rule set have not been successfully compared, the processing circuitry reverts to 806.

If, at 810, the characteristics of one or more respective kernels in the first subset and the dynamic rule set have been successfully compared, the processing circuitry advances to 812. At 812, the processing circuitry (e.g., CPU 406, GPU 408, and/or Logic Units 420) identifies a second subset of the first subset of kernels based on the comparing. In some embodiments, the processing circuitry may, at least in part, utilize memory 404 to identify a second subset of the first subset of kernels based on the comparing. In some embodiments, processing circuitry may, at least in part, utilize I/O ports 412 to identify a second subset of the first subset of kernels based on the comparing.

At 814, the processing circuitry (e.g., CPU 406, GPU 408, and/or Logic Units 420) generates, automatically without human intervention, one or more instructions to combine the second subset of kernels. In some embodiments, the processing circuitry may, at least in part, utilize memory 404 to generate, automatically without human intervention, one or more instructions to combine the second subset of kernels. In some embodiments, processing circuitry may, at least in part, utilize I/O ports 412 to generate, automatically without human intervention, one or more instructions to combine the second subset of kernels.

At 816, the processing circuitry (e.g., CPU 406, GPU 408, and/or Logic Units 420) updates the neural network based on the one or more instructions. In some embodiments, the processing circuitry may, at least in part, utilize memory 404 to update the neural network based on the one or more instructions. In some embodiments, processing circuitry may, at least in part, utilize I/O ports 412 to update the neural network based on the one or more instructions.

At 818, the processing circuitry (e.g., CPU 406, GPU 408, and/or Logic Units 420) adjusts the hardware resource level based on the updated neural network. In some embodiments, the processing circuitry may, at least in part, utilize memory 404 to adjust the hardware resource level based on the updated neural network. In some embodiments, processing circuitry may, at least in part, utilize I/O ports 412 to adjust the hardware resource level based on the updated neural network.

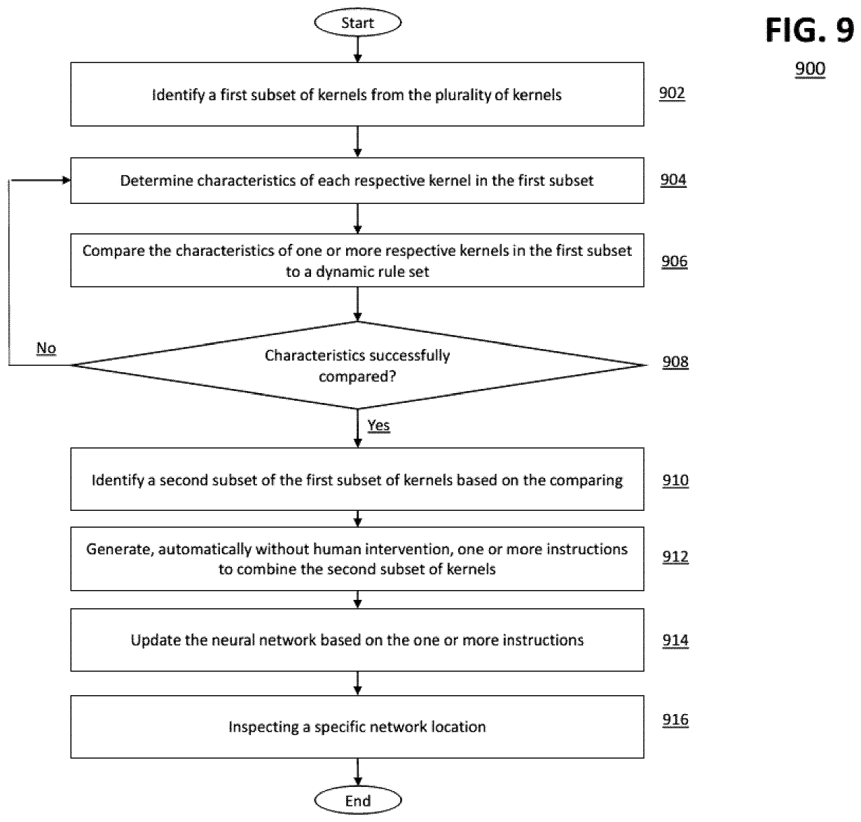

FIG. 9 is an example of an illustrative flowchart 900 of inspecting a dynamically updated neural network comprising a plurality of kernels, in accordance with some embodiments of the present disclosure. At 902, the processing circuitry (e.g., CPU 406, GPU 408, and/or Logic Units 420) identifies a first subset of kernels from the plurality of kernels. In some embodiments, the processing circuitry may, at least in part, utilize memory 404 to identify the first subset of kernels from the plurality of kernels. In some embodiments, processing circuitry may, at least in part, utilize I/O ports 412 to access other logic units and/or data structures to identify the first subset of kernels from the plurality of kernels.

At 904, the processing circuitry (e.g., CPU 406, GPU 408, and/or Logic Units 420) determines characteristics of each respective kernel in the first subset. In some embodiments, the processing circuitry may, at least in part, utilize memory 404 to determine the characteristics of each respective kernel in the first subset. In some embodiments, processing circuitry may, at least in part, utilize I/O ports 412 to access other logic units and/or data structures to determine the characteristics of each respective kernel in the first subset.

At 906, the processing circuitry (e.g., CPU 406, GPU 408, and/or Logic Units 420) compares the characteristics of one or more respective kernels in the first subset to a dynamic rule set. In some embodiments, the processing circuitry may, at least in part, utilize memory 404 to compare the characteristics of one or more respective kernels in the first subset to a dynamic rule set. In some embodiments, processing circuitry may, at least in part, utilize I/O ports 412 to compare the characteristics of one or more respective kernels in the first subset to a dynamic rule set.

At 908, the processing circuitry (e.g., CPU 406, GPU 408, and/or Logic Units 420) determines whether the characteristics of one or more respective kernels in the first subset and the dynamic rule set have been successfully compared. If, at 908, the characteristics of one or more respective kernels in the first subset and the dynamic rule set have not been successfully compared, the processing circuitry reverts to 904.

If, at 908, the characteristics of one or more respective kernels in the first subset and the dynamic rule set have been successfully compared, the processing circuitry advances to 910. At 910, the processing circuitry (e.g., CPU 406, GPU 408, and/or Logic Units 420) identifies a second subset of the first subset of kernels based on the comparing. In some embodiments, the processing circuitry may, at least in part, utilize memory 404 to identify a second subset of the first subset of kernels based on the comparing. In some embodiments, processing circuitry may, at least in part, utilize I/O ports 412 to identify a second subset of the first subset of kernels based on the comparing.

At 912, the processing circuitry (e.g., CPU 406, GPU 408, and/or Logic Units 420) generates, automatically without human intervention, one or more instructions to combine the second subset of kernels. In some embodiments, the processing circuitry may, at least in part, utilize memory 404 to generate, automatically without human intervention, one or more instructions to combine the second subset of kernels. In some embodiments, processing circuitry may, at least in part, utilize I/O ports 412 to generate, automatically without human intervention, one or more instructions to combine the second subset of kernels.

At 914, the processing circuitry (e.g., CPU 406, GPU 408, and/or Logic Units 420) updates the neural network based on the one or more instructions. In some embodiments, the processing circuitry may, at least in part, utilize memory 404 to update the neural network based on the one or more instructions. In some embodiments, processing circuitry may, at least in part, utilize I/O ports 412 to update the neural network based on the one or more instructions.

At 916, the processing circuitry (e.g., CPU 406, GPU 408, and/or Logic Units 420), in response to updating the neural network, inspects a specific network location, wherein the specific network location is located away from a network location of the second subset. In some embodiments, processing circuitry may, at least in part, utilize I/O ports 412 to inspect the specific network location. In some embodiments, processing circuitry may, at least in part, utilize I/O components 414 to inspect the specific network location.

It is contemplated that some suitable steps or suitable descriptions of FIGS. 7-9 may be used with other suitable embodiment of this disclosure. In addition, some suitable steps and descriptions described in relation to FIGS. 7-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 4-6 could be used to perform one or more of the steps in FIGS. 7-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

This disclosure covers various embodiments, including, but not limited to, the following embodiments. A method for dynamically updating a neural network comprising a plurality of kernels, the method comprises: identifying a first subset of kernels from the plurality of kernels; determining characteristics of each respective kernel in the first subset; comparing the characteristics of one or more respective kernels in the first subset to a dynamic rule set; in response to the comparing: identifying a second subset of the first subset of kernels based on the comparing; generating, automatically without human intervention, one or more instructions to combine the second subset of kernels; and updating the neural network based on the one or more instructions.

Another embodiment includes a method for dynamically updating a neural network comprising a plurality of kernels for a hardware resource, the method comprising: identifying a first subset of kernels from the plurality of kernels; determining a hardware resource level of the hardware resource based on the identified first subset of kernels; determining characteristics of each respective kernel in the first subset; comparing the characteristics of one or more respective kernels in the first subset to a dynamic rules set; in response to the comparing: identifying a second subset of the first subset of kernels based on the comparing; generating, automatically without human intervention, one or more instructions to combine the second subset of kernels; updating the neural network based on the one or more instructions; and adjusting the hardware resource level based on the updated neural network.

Yet another embodiment includes a method for inspecting a dynamically updated neural network comprising a plurality of kernels, the method comprising: identifying a first subset of kernels from the plurality of kernels; determining characteristics of each respective kernel in the first subset; comparing the characteristics of one or more respective kernels in the first subset to a dynamic rules set; in response to the comparing: identifying a second subset of the first subset of kernels based on the comparing; generating, automatically without human intervention, one or more instructions to combine the second subset of kernels; updating the neural network based on the one or more instructions; and in response to updating the neural network, inspecting a specific network location, wherein the specific network location is located away from a network location of the second subset.

What is claimed is:

1. A method for dynamically updating a neural network comprising a plurality of kernels, the method comprising:
identifying a first subset of kernels from the plurality of kernels;
determining characteristics of each respective kernel in the first subset;
comparing the characteristics of one or more respective kernels in the first subset to a dynamic rule set;
in response to the comparing:
identifying a second subset of kernels from the first subset of kernels based on the comparing;
automatically generating one or more instructions to combine the second subset of kernels; and
updating the neural network based on the one or more instructions.

2. The method of claim 1, wherein the one or more instructions comprise instructions to copy two or more tensors to a single memory block prior to performance of a concatenation operation.

3. The method of claim 1, wherein the one or more instructions comprise instructions to combine at least two of:
a prolog operation;
a main operation; or
an epilog operation.

4. The method of claim 1, wherein the one or more instructions comprise instructions to perform one or more of reordering a processing of the plurality of kernels, or reducing a numerical precision of the processing.

5. The method of claim 1, wherein the identifying a second subset further comprises identifying the second subset of kernels according to a similarity of operations instructed to be performed using kernels of the second subset of kernels.

6. The method of claim 1, wherein the dynamic rule set includes an input count rule.

7. The method of claim 1, wherein the automatically generating further comprises automatically generating one or more instructions to combine the second subset of kernels according to an execution order having one or more of a reduced number of memory fetch operations or a reduced number of memory store operations.

8. The method of claim 1, wherein the automatically generating further comprises automatically generating one or more instructions to combine the second subset of kernels according to a similarity between the kernels of the second subset of kernels.

9. The method of claim 1, further comprising adjusting a hardware resource level based on the updated neural network.

10. The method of claim 9, wherein the hardware resource level comprises one or more of a memory quantity, a processing circuitry, a graphical processing unit circuitry, a cache quantity, a number of discrete processing modules, or a hard disk space.

11. The method of claim 1, further comprising generating one or more instructions to dynamically allocate a memory during execution of the neural network.

12. The method of claim 1, further comprising generating one or more instructions to perform multiple executions of the second subset of kernels, each execution being performed using a subset of a full set of inputs to the second subset of kernels.

13. The method of claim 12, further comprising generating one or more instructions to combine outputs of the multiple executions.

14. The method of claim 1, further comprising inspecting a predetermined portion of the updated neural network during execution of the updated neural network.

15. The method of claim 1, further comprising inserting one or more analysis nodes at portions of the updated neural network, each analysis node configured to generate an output of the corresponding portion of the updated neural network.

16. The method of claim 15, further comprising dynamically enabling or disabling one or more of the analysis nodes during execution of the updated neural network.

17. The method of claim 1, wherein the identifying a second subset further comprises identifying the second subset of kernels according to a reduction of memory access operations.

18. A method for dynamically updating a neural network comprising a plurality of kernels for a hardware resource, the method comprising:
determining a hardware resource level of the hardware resource based on the neural network;
combining kernels of the neural network according to one or more rules of a dynamic rules set so as to form an updated neural network; and
adjusting the hardware resource level based on the updated neural network.

19. The method of claim 18, wherein the combining further comprises copying two or more tensors to a single memory block prior to performance of a concatenation operation.

20. The method of claim 18, wherein the combining further comprises combining at least two of:
a prolog operation;
a main operation; or
an epilog operation.

21. The method of claim 18, wherein the combining further comprises performing one or more of reordering a processing of the kernels, or reducing a numerical precision of the processing.

22. The method of claim 18, wherein the combining further comprises selecting the kernels for combination, according to a similarity of operations of the kernels.

23. The method of claim 18, wherein the dynamic rules set includes an input count rule.

24. The method of claim 18, wherein the combining further comprises combining the second subset of kernels according to an execution order having one or more of a reduced number of memory fetch operations or a reduced number of memory store operations.

25. The method of claim 18, wherein the combining further comprises combining the second subset of kernels according to a similarity between the kernels.

26. The method of claim 18, wherein the hardware resource level comprises one or more of a memory quantity, a processing circuitry, a graphical processing unit circuitry, a cache quantity, a number of discrete processing modules, or a hard disk space.

27. The method of claim 18, further comprising generating one or more instructions to dynamically allocate a memory during execution of the updated neural network.

28. The method of claim 18, further comprising generating one or more instructions to perform multiple executions of the kernels, each execution being performed using a subset of a full set of inputs to the kernels.

29. The method of claim 28, further comprising generating one or more instructions to combine outputs of the multiple executions.

30. The method of claim 18, further comprising inspecting a predetermined portion of the updated neural network during execution of the updated neural network.

31. The method of claim 18, further comprising inserting one or more analysis nodes at portions of the updated neural network, each analysis node configured to generate an output of the corresponding portion of the updated neural network.

32. The method of claim 31, further comprising dynamically enabling or disabling one or more of the analysis nodes during execution of the updated neural network.

33. The method of claim 18, wherein the rules comprise one or more rules for reducing a number of memory access operations.

34. A method for inspecting a dynamically updated neural network comprising a plurality of kernels, the method comprising:
combining two or more kernels of the neural network according to one or more rules of a dynamic rules set, so as to form combined kernels of an updated neural network; and
inspecting a specific network location, wherein the specific network location is located remotely relative to a network location of the combined kernels.

35. The method of claim 34, wherein the combining further comprises copying two or more tensors to a single memory block prior to performance of a concatenation operation.

36. The method of claim 34, wherein the combining further comprises combining two or more of:
a prolog operation;
a main operation; or
an epilog operation.

37. The method of claim 34, wherein the combining further comprises one or more of reordering a processing of the kernels, or reducing a numerical precision of the processing.

38. The method of claim 34, wherein the combining further comprises selecting the kernels for combination, according to a similarity of operations of the kernels.

39. The method of claim 34, wherein the dynamic rule set includes an input count rule.

40. The method of claim 34, wherein the combining further comprises combining the kernels according to an execution order having one or more of a reduced number of memory fetch operations or a reduced number of memory store operations.

41. The method of claim 34, wherein the combining further comprises combining the kernels according to a similarity between the kernels of the second subset of kernels.

42. The method of claim 34, further comprising adjusting a hardware resource level based on the updated neural network.

43. The method of claim 42, wherein the hardware resource level comprises one or more of a memory quantity, a processing circuitry, a graphical processing unit circuitry, a cache quantity, a number of discrete processing modules, or a hard disk space.

44. The method of claim 34, further comprising dynamically allocating a memory during execution of the neural network.

45. The method of claim 34, further comprising performing multiple executions of the kernels, each execution being performed using a subset of a full set of inputs to the kernels.

46. The method of claim 45, further comprising generating one or more instructions to combine outputs of the multiple executions.

47. The method of claim 34, further comprising inserting one or more analysis nodes at portions of the updated neural network, each analysis node configured to generate an output of the corresponding portion of the updated neural network.

48. The method of claim 47, further comprising dynamically enabling or disabling one or more of the analysis nodes during execution of the updated neural network.

49. The method of claim 34, wherein the rules comprise one or more rules for reducing a number of memory access operations.
